(19) United States
(12) Patent Application Publication
(10) Pub. No.: US 2006/0086530 A1
(43) Pub. Date: Apr. 27, 2006

(54) Wiring connector organizer

(76) Inventor: Robert Knabel, Milwaukee, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/970,972

(22) Filed: Oct. 21, 2004

(51) Int. Cl. H01B 7/00

(52) U.S. Cl. 174/135

(57) ABSTRACT

The present invention is a push-in wiring connector organizer adapted to be secured within a junction box or panel enclosure and capable of securely engaging and organizing a number of self-contained wiring connectors. The organizer includes a pair of biasing members secured at one end of the base and disposed on opposite sides of a central channel that receives a number of wiring connectors therein. The pair of biasing members are outwardly movable to enable the connectors to be inserted within the channel, and inwardly movable to lock the connectors within the channel. The organizer also includes an identifying means holder disposed on one or both of the biasing members within which identifying labels or other indicia can be attached in order to provide an easy to view identifier for each of the wiring connectors secured within the organizer.

### FIELD OF THE INVENTION

The present invention relates to commercial, industrial, and residential electric wiring connectors, and more specifically to an organizer for use in junction boxes, junction panels or electrical equipment assembly's, to retain and organize the wiring connectors and terminals located therein.

### BACKGROUND OF THE INVENTION

When installing the wiring for a building, an electrical panel, or an electrical assembly, a number of electric wiring connections must be made to ensure that the various lights, switches, outlets, assorted electrical components, and other electrical terminals of the building or assembly work as intended. In order to ensure that these connections are made properly, electricians have an option of using terminal blocks and various other types of existing wiring devices to securely and safely connect the various wires to one another. When terminal blocks are used, they have a variety of different configurations, depending upon the features desired for the terminal block and/or the manufacture of said device. Regardless of the form of the terminal block or connection device, in almost every case where the electrical connection is made within a junction box or panel, these terminal blocks are adapted to be engaged with a conventional and industry standard DIN rail that is secured to and within the junction box or panel to provide a mounting connection point between the box or panel and the terminal blocks. To make the desired electrical connections, the terminal blocks are secured to the DIN rail in the proper order and appropriately labeled in order to enable an electrician to easily identify the specific connections or circuits made by the various terminal blocks. The wires are then connected to the blocks as required to make the proper electrical connections.

While the terminal blocks and DIN rail combination, along with other existing standard connection devices utilized in making these electrical connections are very useful in making secure and reliable connections between the selected wires and or circuits, the time required to make each of the connections to the terminal blocks or other connection devices and to secure each terminal block to the DIN rail within the junction box is quite time consuming. This time consuming assembly is due to the fact that each of the terminal blocks is formed separately from the remaining blocks. Therefore, each block must be individually secured to the DIN rail in the desired or proper order. The conventional terminal block assemblies are also bounded by one or more end blocks that are secured to the DIN rail on each side of the assembled terminal blocks to maintain the terminal blocks in the desired position on the rail.

Furthermore, because the terminal blocks are designed to make only a certain number of electrical connections between wires, any need to use more than one block to form a larger circuit requires the use of an electrical jumper connected between the required number of blocks that are to be used in forming the circuit. The electrical jumper may take the shape of a metal bar having a number of outwardly extending arms that can each be engaged with a number of adjacent terminal blocks, thereby connecting each of the blocks in single circuit. A jumper can also take the shape or form of a metal bar in various lengths held in place to the terminal blocks by the use of a screw that is torqued down from a vertical position into the top of a predetermined landing on the individual terminal blocks. Because the jumper is normally preformed with a desired length and a predetermined number of arms, most times the jumper must be shortened or otherwise cut to the proper length. Therefore, the time and labor required for the formation of a jumper of the desired size and the connection of the jumper to the individual blocks in a DIN rail is in addition to the time and labor needed to assemble the blocks on the DIN rail, such that the need for jumpers significantly adds to the amount of time necessary in creating the desired electrical assembly connection.

Alternative types of wiring connectors for making similar, secure wiring connections is a self contained wiring connector, or a wire nut. Wire nuts come in a variety of sizes and styles, but in each case are designed to electrically engage two or more wires with one another. Push-in wire connectors are typically designed with multiple openings that are pre-connected to one another by jumpers integrated into the structure of the push in wire connector. Therefore, all of the wires inserted into the openings are also immediately electrically connected to one another to form a single circuit without the need for attaching a separate electrical jumper. The various styles of push-in wire connectors hold the wires inserted into the openings in this engagement by the presence of biased portions of the connector disposed in the openings that compress the wires into engagement with the jumper and with one another by simply inserting the wires into the openings in the push-in wire connector

However, while the use of a push-in wire connector of this type enables multiple wiring connections to be made in a much faster and just as reliable a manner, the push-in wire connector, regardless of construction, or style are not designed to be held in any organized manner within a junction box or other electrical enclosure similar to the arrangement of the terminal blocks and DIN rails. Therefore, when push-in wire connectors are used, they cannot provide a visual and orderly arrangement in which it is readily apparent which wiring connections are made, as compared to the use of a terminal block, and DIN rail assembly. This present limitation of the push-in wiring connectors greatly increases the time and effort required to locate and repair a damaged circuit and thus significantly reduces the usefulness of these push-in wire connectors in many applications.

To overcome these problems with each type of electrical connector, it is desirable to develop a wiring connection organizer that can engage and retain the push-in wire connectors to be utilized in making wiring connections in a relatively fast manner that also arranges the push-in wire connectors in a configuration which provides a very clear indication of what connections are made by the push-in wire connectors retained in the organizer.

### SUMMARY OF THE INVENTION

According to a primary aspect of the present invention, a wiring connection organizer is formed as a sleeve of a generally non-conductive material that is capable of securely receiving and engaging push-in wire connectors of various types and constructions in order to hold the push-in wire connectors within the channel in a desired arrangement. The sleeve includes a number of engaging members located on opposite sides of a channel defined therebetween. The engaging members can be moved between a disengaged and an engaged position in order to enable the push-in wire connector(s) to more easily be positioned within and secured to the organizer. The organizer can then be secured within a junction box or, electrical panel or other similar structure such that various wiring connections can be made using the push-in wire connectors held in the organizer.

According to another aspect of the present invention, the organizer includes a holder for identifying tags or labels on at least one side of the channel defined in the organizer that provide printed information regarding the particular wiring connections made by the adjacent push-in wire connector disposed adjacent to each label or tag. This identifying means enables the push-in wire connectors secured within the organizer to be easily referenced by using the tags in order to allow an electrician to easily identify which wire connector is to be used in making a selected electrical connection during initial installation of the wiring, or later during an investigation of a faulty connection.

According to still a further aspect of the present invention, the organizer can be formed as a unitary structure such that no additional pieces are required to be attached to or assembled with the organizer in order to enable an organizer to hold the push-in wire connectors and electrical connections made therein within the organizer. Further, the organizer structure can be incorporated in total or in part into other structures that enhance the functionality of these structures concerning electrical wiring connections made therein. This feature of having a built in push-in wire connector decreases the amount of time and labor involved in making secure electrical connections.

Numerous additional aspects, features and advantages of the present invention will become apparent from the following detailed description taken together with the drawing figures.

### BRIEF DESCRIPTION OF THE DRAWINGS

The drawings illustrate the best mode currently contemplated of practicing the present invention.

In the drawings:

FIG. 1 is an isometric view of a wiring connection organizer constructed according to the present invention and engaging a number of push-in wire connectors;

FIG. 2 is an isometric view of the organizer of FIG. 1 in a disengaged position;

FIG. 3 is a cross-sectional view of the organizer of FIG. 1;

FIG. 4 is a cross-sectional view illustrating a wiring connection member partially engaged with the organizer of FIG. 1;

FIG. 5 is a cross-sectional view of the organizer of FIG. 1 in an engaged position;

FIG. 6 is a bottom plan view of the organizer of FIG. 1;

FIG. 7 is an isometric view of a second embodiment of the organizer of FIG. 1 incorporated into a junction box; and

FIG. 8 is a partially broken away isometric view of the junction box of FIG. 7.

### DETAILED DESCRIPTION OF THE INVENTION

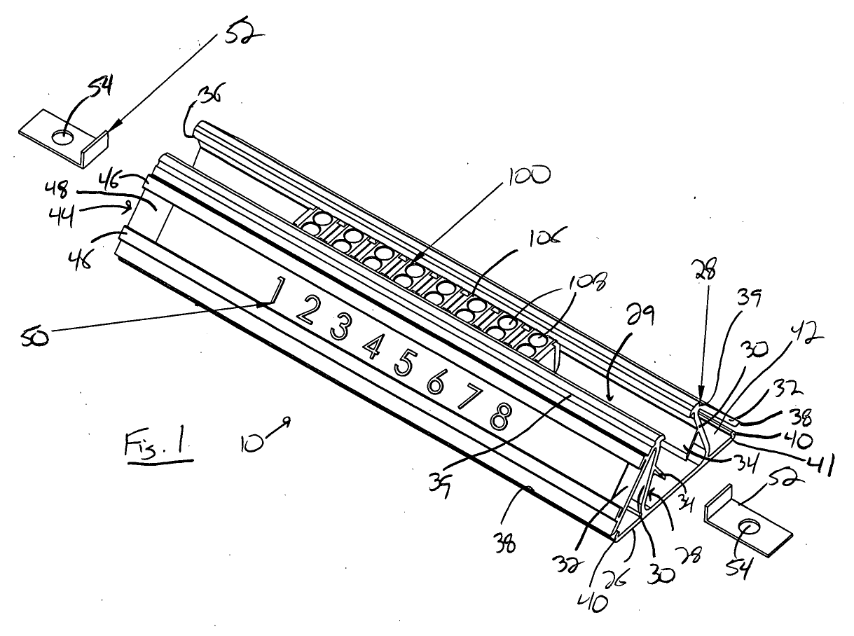

With reference now to the drawing figures in which like reference numerals designate like parts throughout the disclosure, a wiring connection organizer constructed according to the present invention is indicated generally at 10 in FIG. 1. The organizer 10 receives and engages a number of push-in wire connectors 100. The connectors 100 can be any suitable type of self-contained push-in wire connector, such as the push-in wire connectors sold under the name Wall-Nuts™ by WAGO® Corporation of Germantown, Wis. As best shown in FIGS. 1 and 4, the push-in wire connectors 100 include a housing 102 with a lower tapered portion 104 and generally parallel piped upper portion 106. However, the design of the organizer 10 is adaptable to various styles of connectors 100 that have virtually any shape or configuration. The wires (not shown) to be connected in the connector 100 are inserted through openings 108 in the upper portion 106 into engagement with the locking and connecting structures (not shown) disposed within the housing 102.

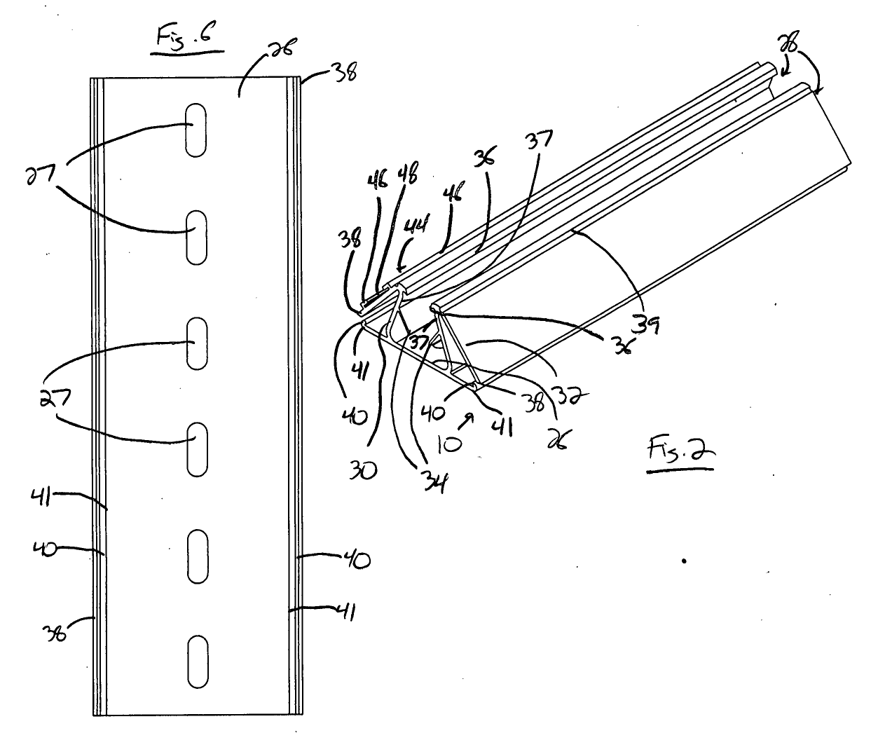

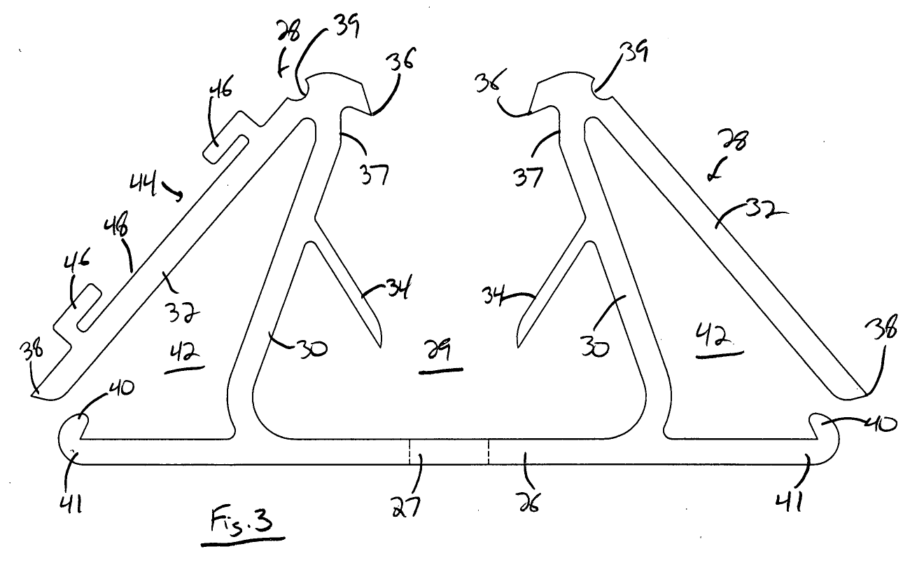

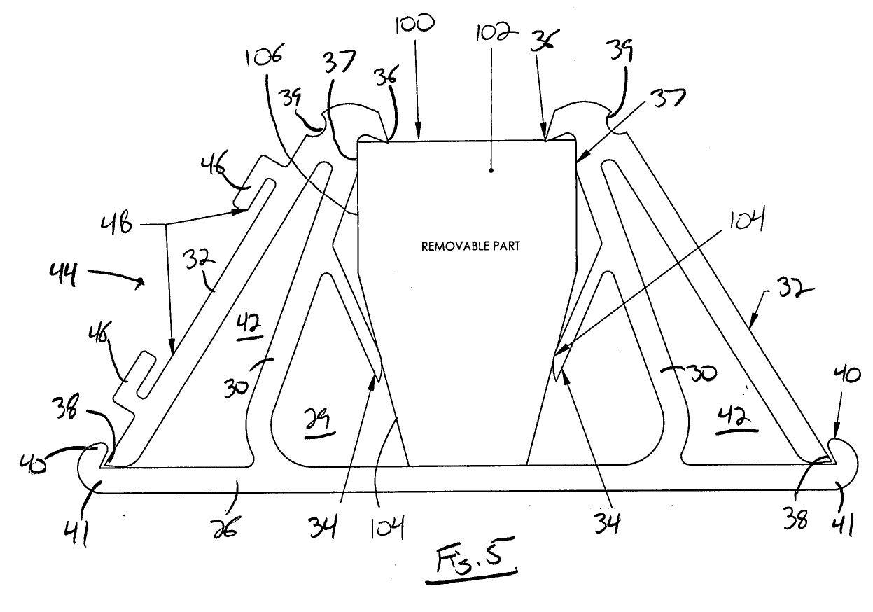

The organizer 10 is typically secured within a junction box (not shown) that includes an enclosure (not shown) secured to a wall of a building and a cover (not shown) pivotally secured to the enclosure. Referring now to FIGS. 1-6, the organizer 10 is formed with a base panel 26 that is positionable against an interior surface (not shown) of the enclosure and that is engaged with the junction box by a fastener (not shown). The fastener can be any conventional type of mechanical fastener, such as a screw, or can be an alternative type fastener, such as an adhesive or double-sided tape that can adhere the organizer 10 within the enclosure. In a preferred embodiment, the base panel 26 is formed with a number of apertures 27 extending through the base panel 26 that can receive a fastener therethrough to secure the organizer 10 where desired.

The base panel 26 also supports a pair of opposed engaging members or wings 28 that extend outwardly from the base 26 on either side of a central channel 29 defined between the engaging members 28 directly above the apertures 27. Each of the engaging members 28 includes an interior panel 30 and an exterior panel 32. The interior panel 30 extends outwardly from the base panel 26 and is preferably integrally formed with the base panel 26. The interior panel 30 includes a gripper flange 34 extending inwardly from the interior panel 30 opposite the exterior panel 32 towards the channel 29, and an inwardly extending engaging tab 36 disposed on the interior panel 30 generally opposite the base panel 26. The flange 34 and tab 36 are also preferably integrally formed with the interior panel 30. Further, the shape of the interior panel 30 forms a generally flat engaging surface 37 directly below the tab 36. Each of the flange 34, tab 36 and surface 37 on each panel 30 are adapted to engage and retain the connectors 100 positioned within the channel 29 in a manner to be described.

The exterior panel 32 is joined to the interior panel 30 adjacent the engaging tab 36 and extends away from the interior panel 30 towards the base panel 26. The exterior panel 32 is preferably integrally formed with the interior panel 30 such that the exterior panel 32 can be moved or flexed with regard to the interior panel 30 while still maintaining the engagement of the interior panel 30 with the exterior panel 32. In an especially preferred embodiment, the interior panel 30 and exterior panel 32 are connected by a living hinge formed by a notch 39 in the material forming the organizer 10.

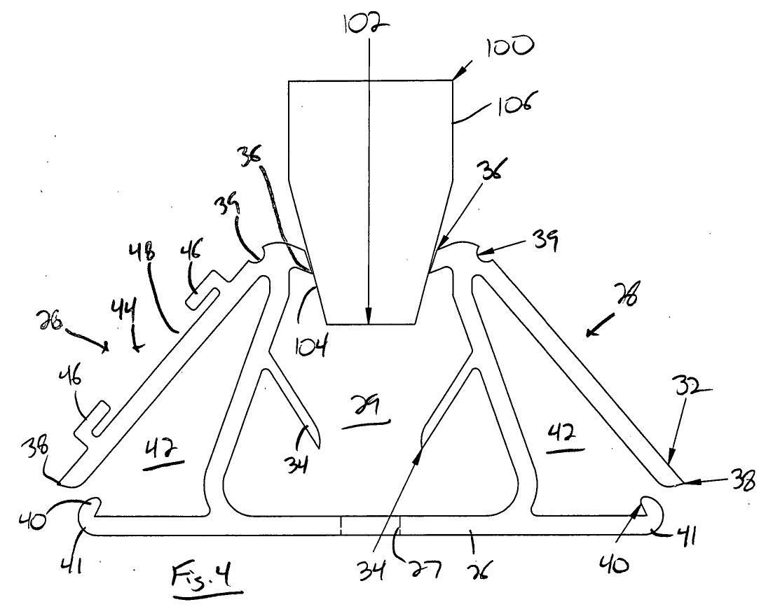

The exterior panel 32 terminates with a lip 38 that is engageable with an upwardly extending locking tab 40 disposed along an outer edge 41 of the base panel 26. The tab 40 can extend the entire length of the base panel 26, or can be formed as a number of tabs 40 spaced from one another along the opposed edges 41 of the base panel 26. When lip 38 is disengaged from the tab 40, the interior and exterior panels 30 and 32 of each engaging member 28 are free to pivot with regard to the base panel 26 and one another. However, when the lip 38 is engaged with the tab 40, the engagement members 28 are rigidly held in an inwardly deflected position best shown in FIG. 5 to maintain the engagement members 28 contact with the connectors 100. In the engaged position, the base panel 26, interior panel 30, and exterior panel 32 define a space 42 therebetween that enables the engagement members 28 to flex slightly such that any stress or force exerted on the organizer 10 can be dissipated by the engagement members 28, and will not damage the organizer 10 or the connectors 100 contained therein. Further, the space 42 also greatly reduces the overall amount of the selected material used to form the organizer 10.

The exterior panel 32 of one or both of the engagement members 28 may also include an indicia receiving means 44 disposed on the exterior panel 32 opposite the space 42. The receiving means 44 can comprise any suitable means for receiving a tag, label, card, or other indicia 50 on the exposed side of the exterior panel 32, but is preferably formed of a pair of inwardly extending L-shaped flanges 46 that define an elongated opening 48 therebetween. A tag 50 can be inserted into the opening 48 between the flanges 46 at one end of the channel and slid along the opening 48 beneath the flanges 46 in order to retain the tag 50 therein. The tag 50 can then be written or marked upon, or can be preprinted in order to provide the proper identifying markings for the different electrical connectors 100 held within the organizer 10. Also, once each of the connectors 100 are properly secured within the organizer 10, in order to prevent any of the connectors 100 from slipping out of one of the open ends of the organizer 10, a pair of stop flanges 52 are secured inadvertently within the channel 29 against the connectors 100 adjacent each end of the channel 29. The stop flanges 52 are preferably L-shaped, but can have any suitable form such as a solid block, and possess an opening 54 therein. A fastener is insertable through the opening 54 to secure the stop flanges 52 in engagement with the outermost connectors 100, and in a preferred arrangement, the openings 54 are aligned with one of the apertures 27 in the base panel 26 such that a single fastener can be used to attach the flange 52 to the panel 26, and the panel 26 to the enclosure.

Looking now at FIGS. 4 and 5, in order to insert one or more of the connectors 100 into the channel 10, initially the lip 38 on each exterior panel 32 of each engagement member 28 is disengaged from the associated locking tab 40 to enable the members 28 to be deflected outwardly away from the channel 29. The push-in wire connectors 100 are then pressed downwardly into the channel 29 between the engaging tabs 36 of the members 28, thereby further deflecting the members 28 outwardly, and enabling the connector 100 to slide into the channel 29. As the connector 100 moves downwardly into the channel 29, the lower tapered portion 104 of the connector 100 contacts and deflects outwardly each of the flanges 34 extending from the interior panels 30 into the channel 29. The dimensions of the interior panels 30 for the organizer 10 are chosen such that the lower end of the portion 104 of the connector 100 contacts the base panel 26 as the engaging tabs 36 snap over and engage the top of the upper portion 106 of the connector 100. Therefore, when the tabs 36 are fully engaged over the upper portion 106 of the connector 100, the connector 100 is held in engagement with the organizer 10 within the channel 29 by the engagement of the base panel 26 with the end of the lower portion 104, the engagement of the gripper flanges 34 with the sides of the lower portion 104, the contact of the engagement surfaces 37 of the interior panels 30 with the sides of the upper portion 106, and the engagement of the engaging tabs 36 with the top of the upper portion 106, thereby providing a highly stable and secure arrangement for the connector 100 within the organizer 10. Depending upon the overall length of the organizer 10 and the size of each connector 100, any number of connectors 100 can be engaged with the organizer 10 in this manner.

After the engaging tabs 36 snap into engagement over each connector 100, the exterior panels 32 of each engagement member 28 are pressed inwardly to engage the lips 38 on the panels 32 with the associated locking tabs 40 along the side edges 41 of the organizer 10. The engagement of each lip 38 with the associated locking tab 40 secures the engagement members 28 in an inwardly biased position such that the flanges 34, the tabs 36 and the engagement surfaces 37 of each member 28 are pressed towards and locked in engagement with the exterior surfaces of the connectors 100.

To remove the push-in wire connectors 100 from within the organizer 10, a reverse process is utilized in which the lips 38 on the outer panels 32 of each engagement member 28 are disengaged from the associated locking tabs 40 to enable the engagement member 28 to be pivoted away from the channel 29. The connector 100 can then be grasped and moved upwardly out of the channel 29, or merely slid along the channel 29 outwardly from one end of the organizer 10, if desired. In this manner, after the electrical connections are made using each of the connectors 100, and the connectors 100 are positioned within the organizer 10, any faulty connectors 100 can easily be identified and removed from within the organizer 10 in order to replace the specific connector 100 without disturbing the arrangement of the other connectors 100 in the organizer 10.

Further, in an alternative embodiment, it is contemplated that the organizer 10 can include only a single engagement member 28, with the opposed side of the organizer 10 being formed with a preferably integral stop or alignment member (not shown) utilized to properly align a connector 100 within the channel 29 formed within the organizer 10. Thus, the engagement of the connectors 100 with the organizer 10 involves the movement of only one engagement member 28 into or out of engagement with the connector 100 in the manner described previously. This embodiment can be utilized with certain types of push-in wire connectors 100 having a generally flat side that can be positioned against the alignment member of the organizer 10 opposite the securing member 28, while the securing member 28 securely engages the opposed side of the connector 100.

In addition, the shape and number of the flanges 34 disposed on the interior panels 30 can be varied as necessary in order to enable the flanges 34 to more easily conform to the particular shape of the connector 100 to be secured within the organizer 10, or the flanges 34 can be omitted entirely. The shape of the locking tabs 36 can also be modified in a similar manner for a similar purpose. Furthermore, each of the engagement members 28 can be formed to be removable from the organizer 10.

The materials utilized in the construction of the organizer 10 are only limited by the requirement that these materials be essentially non-conductive due to the electrical connections formed by the connectors 100 that are retained within the organizer 10. Therefore, preferable materials for use in forming the organizer 10 are various plastics, especially those plastics which can be utilized in a conventional extrusion process or an injection molding process, such that the organizer 10 can be preferably formed as a continuous member in such an extrusion process or an injection molding process that is subsequently cut into or preformed into desired length sections forming the organizer 10 for use in securing the connectors 100 within a suitable enclosure. However, the various portions of the organizer 10 can also be formed separately from one another, and later assembled to form the organizer using any suitable means such as a mechanical fastener, an adhesive or suitable welding technique.

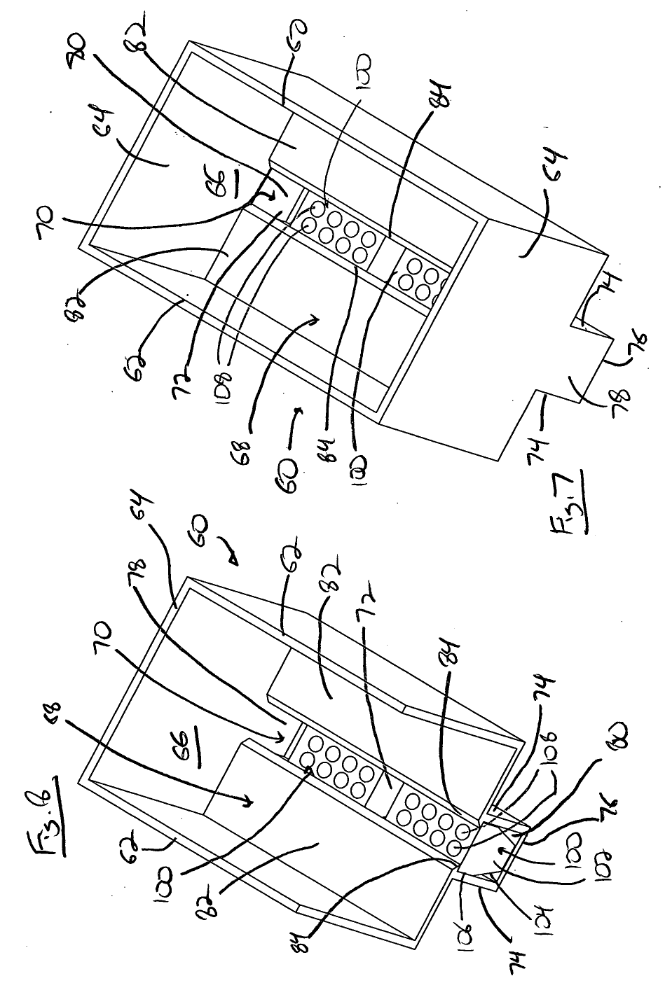

Referring now to FIGS. 7 and 8, still another alternative embodiment of the organizer of the present invention is disclosed in which the organizer 10, in modified form, is integrated into the structure of an existing conventional enclosure, such as an electrical box 60. The box 60 is formed as an open-ended enclosure having a pair of side walls 62 and a pair of end walls 64 joining the side walls 62 and defining an interior 66 for the box 60. A bottom wall 68 extends between the side walls 62 and end walls 64, and it includes an outwardly extending channel 70 disposed along the longitudinal center line of the box 60, but can be disposed or oriented in any configuration on the box 60, such as along one side of the bottom wall 68 or on one or more of the side walls 62 or end walls 64. The channel 70 can be formed integrally with the bottom wall 68, or can be formed separately from the bottom wall and attached thereto over an opening 72 defined in the bottom wall 68. The channel 70 is formed as necessary to conform to the shape of the connectors 100 to be inserted therein, and preferably includes a pair of side walls 74 that are connected at one end to the bottom wall 68 and at the other end to a bottom panel 76 to enclose the channel 70. The channel 70 also includes an end wall 78 disposed at one end of the channel 70 in which can be formed integrally with or separately from the associated end wall 64 of the box 60. At the other end of the channel 70, the channel 70 defines an opening 80 through which the various connectors 100 can be inserted into the channel 70.

To retain the connectors 100 within the channel 70, each section 82 of the bottom wall 68 of the box 60 on opposite sides of the opening 72 includes an inwardly extending flange 84 that projects inwardly from the section 84 of the bottom wall 68 partially over the channel 70. Thus, when the connectors 100 are slid into the channel 70, the flanges 84 prevent the connectors 100 from moving out of the channel 70 and into the box 60. In this position, the wires (not shown) to be connected with each of the connectors 100 can be inserted into the respective openings 108 in each connector 100. Also, similarly to the construction of the organizer 10, the materials utilized in the construction of the box 60 and channel 70 are preferably non-conductive materials due to the particular uses for the box 60 and channel 70.

Various alternatives are contemplated as being within the scope of the following claims particularly pointing out and distinctly claiming the subject matter regarded as the invention.

1. (canceled)

2. The organizer of claim 24 wherein the at least one biasing member comprises:
a) a first biasing member connected to the base panel on one side of a centerline of the base panel; and
b) a second biasing member connected to the base panel generally opposite the first biasing member.

3. The organizer of claim 2 wherein the first and second biasing members form a channel therebetween.

4. The organizer of claim 24 wherein the at least one biasing member is integrally connected to the base panel.

5. An organizer for a number of self-contained push-in wiring connectors, the organizer comprising:
a) a base panel adapted to be secured to a support surface; and
b) at least one biasing member connected to and extending outwardly from the base panel, the at least one biasing member adapted to receive and engage the self-contained electrical wiring connectors, wherein the at least one biasing member comprises:
1) an inner panel connected to the base panel and extending outwardly from the base panel; and
2) an outer panel connected to the inner panel opposite the base panel and extending towards the base panel, wherein the inner panel and the outer panel define a space therebetween.

6. The organizer of claim 5 wherein the inner panel and the outer panel are integrally joined to one another.

7. The organizer of claim 5 wherein the base panel includes at least one locking flange spaced from the inner panel and engageable with the outer panel.

8. The organizer of claim 5 wherein the inner panel includes a locking tab disposed opposite the base panel that is adapted to hold and engage the wiring connectors.

9. The organizer of claim 5 wherein the inner panel includes a positioning flange disposed opposite the outer panel and engageable with the wiring connectors.

10. The organizer of claim 5 wherein the outer panel includes at least one holding member disposed opposite the inner panel and an indicator releasably engageable with the at least one holding member and adapted to identify each of the wiring connectors.

11. The organizer of claim 5 further comprising:
a) a first biasing member disposed on one side of the base panel; and
b) a second biasing member disposed opposite the first biasing member.

12. The organizer of claim 5 wherein the at least one biasing member extends the length of the base panel.

13. The organizer of claim 24 wherein the base panel is formed of a plastic material.

14. The organizer of claim 13 wherein the at least one biasing member is formed of a plastic material.

15. A method for securing a number of self-contained wiring connectors within a connector organizer, the method comprising the steps of:
a) providing a wiring connector organizer including a base panel adapted to be secured to a support surface, and at least one biasing member connected to the base panel at one end and releasably engageable with the base panel at the opposite end, and a channel defined within the organizer adjacent the at least one biasing member and above the base panel;
b) sliding the wiring connectors into the channel and into engagement with the at least one biasing member; and
c) locking the at least one biasing member in engagement with the wiring connectors.

16. The method of claim 15 wherein the at least one biasing member includes a first biasing member disposed on one side of the channel and a second biasing member disposed on the other side of the channel, wherein the step of sliding the wiring connector into the channel comprises engaging the connector with the first biasing member and the second biasing member.

17. A method for securing a number of self-contained wiring connectors within a connector organizer, the method comprising the steps of:
a) providing a wiring connector organizer including a base panel adapted to be secured to a support surface, and at least one biasing member connected to and extending outwardly from the base panel, and a channel defined within the organizer adjacent the at least one biasing member and above the base panel;
b) sliding the wiring connectors into the channel and into engagement with the at least one biasing member, and
c) locking the at least one biasing member in engagement with the wiring connectors wherein the at least one biasing member includes an inner panel connected to the base panel and an outer panel connected to the inner panel opposite the base panel, and wherein the step of locking the at least one biasing member in engagement with the connector comprises engaging the outer panel with the base panel.

18. The method of claim 15 further comprising the step of disengaging the at least one biasing member from the wiring connectors.

19. (canceled)

20. The method of claim 15 further comprising the step of placing an indicating member on the at least one biasing member after locking the at least one biasing member in engagement with the wiring connectors.

21. An organizer for a number of self-contained wiring connectors, the organizer comprising:
a) an enclosure defining an interior and having a pair of opposed side walls, a pair of opposed end walls joining the pair of opposed side walls, and a bottom wall extending between the side walls and end walls, one of the side, end or bottom walls including a generally elongated opening therein;
b) an enclosed channel attached to the one of the side, end, or bottom wall opposite the interior of the enclosure, the channel extending along the opening in the one of the side, end or bottom wall and including an open end adapted to receive an electrical wiring connector therein.

22. The organizer of claim 21, wherein the channel is integrally formed with the enclosure.

23. The organizer of claim 21, wherein the one of the side, end, or bottom wall includes a pair of inwardly extending flanges positioned at least partially over the channel and adapted to retain the connectors within the channel.

24. An organizer for a number of self-contained push-in wiring connectors, the organizer comprising:
a) a base panel adapted to be secured to a support surface; and
b) at least one biasing member adapted to engage the wiring connectors, the at least one biasing member connected to the base panel at one end and for releasably engageable with the base panel at the opposite end.

25. The organizer of claim 24 further comprising a positioning flange extending from the at least one biasing member.

26. An organizer for a number of self-contained push-in wiring connectors, the organizer comprising:
a) a base panel adapted to be secured to a support surface;
b) at least one biasing member connected to and extending outwardly from the base panel, the at least one biasing member adapted to receive and engage the wiring connectors, wherein the organizer and at least one biasing member are formed of a non-conductive material.
